(19) United States
(12) Patent Application Publication
(10) Pub. No.: US 2006/0099396 A1
(43) Pub. Date: May 11, 2006

(54) Nanoporous coatings

(75) Inventors: Jeri'Ann Hiller, Cambridge, MA (US); Jonas D. Mendelsohn, Harrisburg, PA (US); Michael F. Rubner, Westford, MA (US)

Correspondence Address: FISH & RICHARDSON PC, P.O. BOX 1022, MINNEAPOLIS, MN, 55440-1022, US

(73) Assignee: Massachusetts Institute of Technology, a Massachusetts corporation

(21) Appl. No.: 11/246,334

(22) Filed: Oct. 6, 2005

Related U.S. Application Data
(63) Continuation of application No. 10/393,360, filed on Mar. 21, 2003, now abandoned.
(60) Provisional application No. 60/366,269, filed on Mar. 22, 2002.

(51) Int. Cl. B32B 3/26; B32B 3/06; B05D 5/00; B32B 9/00; B32B 27/00

(52) U.S. Cl. 428/304.4; 428/306.6; 428/318.4; 428/319.1; 428/319.3; 427/245

(57) ABSTRACT

Nanoporous coatings can be prepared on a substrate from a polyelectrolyte multilayer by aqueous processing.

### CLAIM OF PRIORITY

This application claims priority under 35 U.S.C. § 119(e) to U.S. Patent Application Ser. No. 60/366,269, filed on Mar. 22, 2002, the entire contents of which are hereby incorporated by reference.

### FEDERALLY SPONSORED RESEARCH OR DEVELOPMENT

The U.S. Government may have certain rights in this invention pursuant to Grant Nos. CTS-9729569 and DMR-9808941 awarded by the National Science Foundation.

### TECHNICAL FIELD

The present invention relates to nanoporous coatings.

### BACKGROUND

Antireflective coatings and surfaces can increase light transmission in optical systems or eliminate unwanted reflections and glare. With the current trend of technology moving rapidly towards polymeric transparent media and optical coatings, the need for antireflection technology and environmentally benign processing methods for polymeric materials of any shape or size has become apparent.

Reflection of radiation from optical components can degrade the performance of technologies that rely on the efficiency of transmitted radiation. A particularly relevant example of such an application is solar cell collectors. Additional applications such as flat panel displays for computers, televisions, and numerous other technologies, windows in buildings and automobiles, instrument covers, and projection systems to name a few, are plagued with the creation of ‘ghost images’ or veiling glares originating from stray and multiple reflections from optical components. Reducing the intensity of reflected light can improve the overall quality, performance, and efficiencies of such systems which translates to: increasing transmission, improving contrast, reducing glare, as well as eliminating ghost images.

One approach to alleviating this problem is the application of a quarter wave thickness of an antireflective coating whose index of refraction is the square root of that of the substrate. The low index requirement for the zero-reflectivity condition in the single-layer antireflective coatings can limit the design of antireflective coatings. An antireflective coating can operate as a result of destructive interference of radiation reflected from the air/coating and coating/substrate interface with the result being that a minimum in reflectance occurs at the design wavelength.

While being ideal for applications that require elimination of reflections over narrow bandwidths, the single-wavelength antireflection coating is less suited to applications that require minimized reflections over a wide wavelength range. Such broadband antireflectivity can be achieved ideally by the creation of a graded index of refraction between the surrounding medium and the substrate material. In the ideal case, the antireflective coating has a graded index of refraction going from the surface of the coating, which matches the surrounding medium (generally air with n=1), and increases gradually to an index closely matching that of the substrate.

### SUMMARY

Nanoporous coatings can be prepared on a substrate from a polyelectrolyte multilayer by aqueous processing. The nanoporous coating can be an antireflective or antiglare coating. The nanoporous coating can be a portion of a membrane, a biomaterial, or a stimulus-responsive device.

In one aspect, a method of forming a nanoporous coating on a substrate includes forming a polyelectrolyte film on a surface of the substrate, and contacting the polyelectrolyte film with an aqueous medium for a period of time to generate a plurality of nanopores in the film. A method of making a porous polymeric material includes providing a polymeric material, and contacting the polymeric material with a nanopore-generating medium for a period of time to generate a plurality of nanopores in the polymeric material. Contacting the polymeric material with the nanopore-generating medium can include patterning the nanopores in the polymeric material. The period of time can be less than five minutes. Providing the polymeric material can include forming a film on a surface of a substrate, or forming a film on a first surface and a second surface of the substrate.

In another aspect, a method of forming a nanoporous coating on a substrate includes forming a polyelectrolyte film on a first surface and a second surface of the substrate, and contacting the polyelectrolyte film with an aqueous medium for a period of time to generate a plurality of nanopores in the film.

In another aspect, a method for altering the porosity of a polymeric material includes contacting the polymeric material with a nanopore-altering medium for a period of time to alter the porosity of the polymeric material. The nanopore-altering medium can introduce nanopores to the polymeric material or remove nanopores from the polymeric material. The method can include stabilizing the polymeric to changes in porosity. The method can include contacting the polymeric material with a nanopore-removing medium to remove the nanopores. The nanoporous coating can be an antireflective coating. The film can have a thickness of between 50 nanometers and 20 micrometers. In some embodiments, the film can have a thickness of 10 micrometers or less.

The polymeric material can include a polyelectrolyte. The polymeric material can be at least a portion of a film. The film can be a polyelectrolyte film, which can be composed of at least a polyanion/polycation bilayer. The film can form a pattern on the surface of the substrate.

The polyelectrolyte film can be a multilayer film. The salt concentration in the aqueous medium can be less than 1 M. The period of time can be less than 5 minutes. In certain circumstances, substantially no material is removed from the film after forming the film.

The polyelectrolyte film can be formed on the surface by, for example, contacting the surface with an aqueous solution of a polymer. The polymer can be a polyanionic polymer or a polycationic polymer. The polyelectrolyte film can be contacted with a medium to remove the nanopores in the film. The polyelectrolyte film can be contacted with the aqueous medium to form a pattern on the film with the medium.

The nanopore-generating medium can be an aqueous medium. The aqueous medium can be a water-containing medium. The aqueous medium can be substantially aqueous and can include mixtures of water with other solvents. In certain circumstances, the aqueous medium can be free of organic solvents. The aqueous medium can include a salt, for example, at a concentration of less than 1 molar. The aqueous medium can have a pH of less than 7, less than 5, less than 4, less than 3, or 2.5 or less.

In another aspect, an optical component includes a substrate having a nanoporous polymeric material, such as a coating, on a surface of the substrate. The nanoporous coating can include a plurality of layers of polyelectrolyte and having a plurality of nanopores in the coating. The coating can have a refractive index gradient through the thickness of the coating. The refractive index gradient can increase monotonically toward the surface of the substrate. The optical transmission through the substrate and nanoporous coating can be greater than 97% between 400 nm and 700 nm, or greater than 90% between 1200 nm and 1600 nm. The component can include a second antireflective coating on a second surface of the substrate. The component can include a second nanoporous polymeric material on a second surface of the substrate. The nanoporous polymeric material can be at least a portion of a film and can render a surface of the component antireflective. The pores of the polymeric material can have diameters shorter than a wavelength of visible light contacting the surface of the component. The nanopores can form a pattern in the polymeric material.

The substrate can include an inorganic material, an organic polymer, or mixtures thereof. The surface of the substrate can have an irregular shape. The surface of the substrate can be curved.

Broadband antireflectivity can be attained using an inexpensive, simple process employing aqueous solutions of polymers. The process can be used to apply a high-efficiency conformal antireflective coating to virtually any surface of arbitrary shape, size, or material. The process can be used to apply the antireflective coating to more than one surface at a time and can produce coatings that are substantially free of pinholes and defects, which can degrade coating performance. The porous polymeric material can be antireflective.

In another aspect, an environmental response device includes a porous polymeric material, and a nanopore-altering medium in contact with the porous polymeric material. The porosity of the polymeric material can automatically respond to changes in a property of the nanopore-altering medium. The property can be pH or salt concentration. The polymeric material can be at least a portion of a film. The device can include a compound in contact with the polymeric material. The compound has a size suitable to pass through the pores of the polymeric material. The compound can be embedded in the polymeric material or located in the nanopore-altering medium.

In another aspect, a method for delivering a compound includes contacting a delivery device including a polymeric material and a compound with a nanopore-generating medium for a period of time to generate a plurality of nanopores in the polymeric material, and allowing the compound to pass through pores in the polymeric material.

In another aspect, a device for delivering a compound includes a nanoporous polymeric material, and a compound in contact with the polymeric material.

The pores in the polymeric material can be micropores or nanopores. The compound can contact the polymeric material before the polymeric material is contacted with a nanopore-generating medium for a period of time to generate a plurality of nanopores in the polymeric material.

The compound can be located or dissolved in an aqueous medium, such as the nanopore-generating medium. The compound can be enclosed by the polymeric material or embedded in the polymeric material. The compound can be a drug.

Other features, objects, and advantages will be apparent from the description and drawings, and from the claims.

### DESCRIPTION OF DRAWINGS

FIG. 1 is a graph depicting transmission vs. wavelength for a 13-layer polymer coating with porosity treatments of (2) 10 seconds, (3) 30 seconds and, (4) 60 seconds as compared to (1) uncoated glass. The nanoporous film is coated on both sides of the glass substrate.

FIG. 2 is a graph depicting transmission vs. wavelength for the treated (coating on both sides) (2) vs. the untreated polystyrene petri dish (1).

FIG. 3 is a graph depicting transmission vs. wavelength of an ITO-coated glass surface treated with an anti-reflection coating (2) compared to the untreated surface (1).

FIG. 4 is a graph depicting: (a) percent reflection (% Reflection) vs. wavelength for a 21-layer nanoporous film coated on both sides of a polystyrene slide: (1) the reflection of the untreated polystyrene vs. (2) the drastically reduced reflection of the polymer slide coated with the antireflection nanoporous film; (b) Transmission vs. wavelength for the treated (3) vs. the untreated polystyrene slide (4).

### DETAILED DESCRIPTION

Polyelectrolyte multilayers can form high-performance antireflective coatings in the visible and near infrared spectral ranges. The processing of these optical coatings is based on the spontaneous electrostatically-driven layer-by-layer molecular assembly of oppositely charged polyelectrolytes, which can create large-scale uniform coatings with precisely tuned properties. See, for example, G. Decher, Science 1997, 277, 1232, which is incorporated by reference in its entirety. Charged polyelectrolytes can be assembled in a layer-by-layer fashion. See, for example, Mendelsohn et al., Langmuir 2000, 16, 5017, and Fery et al., Langmuir 2001, 17, 3779, each of which is incorporated by reference in its entirety. The properties of weakly charged polyelectrolytes can be precisely controlled with pH. See, for example, Shiratori et al., Macromolecules 2000, 33, 4213, which is incorporated by reference in its entirety.

A polyelectrolyte has a backbone with a plurality of charged functional groups attached to the backbone. A polyelectrolyte can be polycationic or polyanionic. A polycation has a backbone with a plurality of positively charged functional groups attached to the backbone, for example poly(allylamine hydrochloride). A polyanion has a backbone with a plurality of negatively charged functional groups attached to the backbone, such as poly(acrylacrylate, a salt of polyacrylic acid). Some polyelectrolytes can lose their charge (i.e., become electrically neutral) depending on conditions such as pH. Some polyelectrolytes, such as copolymers, can include both polycationic segments and and polyanionic segments.

These methods can provide a new level of molecular control over the deposition process by simply adjusting the pH of the processing solutions. The nonporous polyelectrolyte multilayers can form porous thin film structures induced by a simple acidic, aqueous process. Tuning of this porosity process, including the manipulation of such parameters as salt (ionic strength), temperature, or surfactant chemistry, has led to the creation of nanopores. A nanopore has a diameter of less than 150 nm, for example, between 1 and 120 nm or between 10 and 100 nm. Nanoporous coatings can create versatile broadband (over a wide wavelength range) antireflective and antiglare coatings. The nanopores can have diameters of less than 100 nm. The coatings can be free of micropores. A micropore has a diameter of greater than 200 nm. A nanoporous material has a nanoporous structure that is substantially free of micropores.

These porous multilayer thin films could have applications as low dielectric and low refractive index coatings. Such films can be used for delivery of compounds. For example, a device can includes a drug and a polymeric film. The film can be treated with a solution to generate pores in the film, and the drug can be released from the device by passing through the pores. The solution can be an aqueous solution, such as an acidic solution or a salt solution. The drug can be enclosed by the film or embedded in the film. Selecting an appropriate solution can control the size and number of pores in the film, thus controlling the rate of drug release. The pores generated in the polymer can be nanopores.

A nanoporous film can also be used in environmental response applications. A polymeric film on a surface can be exposed to changes in local properties, for instance pH or salt concentration. The pH or salt concentration changes can be induced by environmental conditions, for example, changes in temperature or exposure to light. Changes in local properties can cause the film to respond by changing the porosity of the film. Altered porosity of the film can affect other properties of the film, such as reflectivity or permeability. A compound can be associated with the film, and the rate of release of the compound automatically adjusted in response to environmental changes. More specifically, regions of a polymer film on a substrate are selectively exposed to light in the presence of a photoacid to change the pH. Local pH changes in the regions exposed to light can generate nanopores selectively in those regions. Nanoporous regions can be antireflective.

A nanopore-generating medium is a substance that introduces nanopores in a polymeric material. For example, the nanopore-generating medium can be an acidic aqueous solution, or an aqueous salt solution. Under certain pH conditions a homogeneous multilayer film of poly(allylamine hydrochloride)/poly(acrylic acid) (PAH/PAA) undergoes a transition to a microporous film when placed in a low-pH aqueous environment. The spinodal decomposition of the homogeneous system occurs when films prepared at pH conditions of 7.5/3.5 for PAH and PAA, respectively (as well as other systems) are subsequently immersed in pH ˜2.4 water, for example. Unexpectedly, the length-scale of the porosity can be advantageously controlled by lowering the pH of the aqueous solution below pH 2 or by the addition of low concentrations of various salts (MgCl₂ and NaCl) to the low-pH water to selectively create either nano- or micro-porous films. Moreover, multilayer polyelectrolyte films assembled at virtually any pH can be induced to form nanopores. Other combinations of polyelectrolytes can be selected to create multilayers that form nanopores. For example, this transition also occurs in poly (diallyl dimethyl ammonium chloride)/PAA (PDAC/PAA) films assembled under a variety of pH conditions.

The nanoporous transition at several pH combinations and in various polymer films lends this system to the creation of broadband antireflection coatings for the visible and near infrared spectral ranges. Structures assembled from PAH and PAA at characteristic pH values have very unique properties in terms of relative composition of PAH and PAA, and the resultant refractive index when made nanoporous. PAH/PAA systems can form broadband antireflective heterostructures at various pH combinations.

The nanoporosity is introduced in such a way that highly transparent, non-scattering films, suitable for high performance optical coatings can be created. The resultant porous multilayers can possess a level of graded porosity and can be suitable for broadband antireflection coating technology. The index of refraction as well as the porosity gradient can be precisely tailored in the multilayers by varying film thickness and immersion time, pH, and salt concentration in the porosity-inducing aqueous step. The form of the gradient profile can be related to the processing conditions.

A fluoropolymer-based (NAFION®) coating has been assembled via the layer-by-layer assembly technique, which has an index of refraction of 1.39. The peak transmission (96.5%) of these coatings can be precisely tuned in the visible and near infrared spectra ranges by varying the number of bilayers of polymer deposited. This polymer film can have antireflective properties comparable to MgF₂ (n=1.38), which is a widely used antireflective coating. Heterostructures containing the fluoropolymer-based coating and nanoporous films can be used to create broadband antireflection coatings with high efficiency.

The nanoporous structures can be rendered stable to further transformation by a post-processing treatment, such as a heat treatment, which essentially “locks-in” the porosity. The adhesion resistance and durability of the nanoporous films can be enhanced by the incorporation of titania nanoparticles into the polyelectrolyte multilayers. These nanoparticle/polymer composites can undergo the nanoporosity transition to form films with lowered indices of refraction. Additionally, the adhesion of the films can be further fortified by the application of treatments that have proved effective for multilayers. Such treatments can include silane treatments on glass and the pre-deposition of various other well-studied polymer systems as interface modifiers that do not undergo this porosity transformation. The process presented here is aqueous-based, low-cost, environmentally sound, and creates highly transmissive films on both sides of a given substrate. These highly uniform films can be upscaled to large-area applications on a variety of substrates.

PAH/PAA (7.5/3.5) films of initial thickness ranging from 11-21 layers (which corresponds to ˜400 to 1000 Å) undergo transitions from homogeneous to porous structures with features on the nano- and micro-scale. In a glass slide half-coated with a 13 layer nanoporous coating created by a treatment for 60 seconds in pH 2.4 0.1M MgCl₂ solution, transmission through the coated side is significantly enhanced as is the contrast of the white print against the black background as compared to the uncoated half of the glass slide. The reflection and glare were drastically reduced, while the overall quality and legibility of the image on the coated side was enhanced.

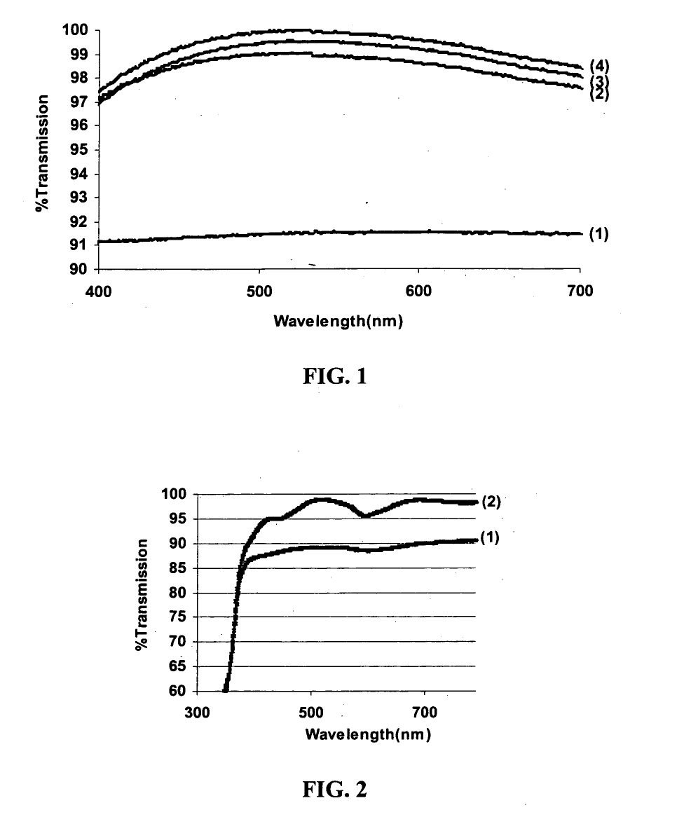

This dramatic improvement is corroborated by the transmission characteristics of the antireflective coating shown above and is illustrated in FIG. 1: curve (4). FIG. 1 shows the relationship between transmission and wavelength of the 13-layer nonporous coating applied to both sides of a glass slide which has an index of 1.52 for three different porosity treatments. FIG. 1 illustrates the high transmission that results in the visible range of 400 nm to 700 nm. The transmission of glass is increased from 91.5% to an average of 99% in the range of 450 nm to 700 nm in the case of the 60 second porosity treatment. The transmission exhibits a maximum of 99.9% in the area of 500 nm. Since various low indices of refraction can be precisely tailored in the range of 1.18-1.55 and potentially even lower, the low-index requirement for high-efficiency antireflective coatings can be attained for a wide variety of substrate materials.

This striking improvement in transmission was demonstrated on polymeric materials such as polystyrene and plexiglass (e.g., poly(methyl methacrylate)), which would be dissolved in an organic solvent-based method. In the case of polystyrene, for example, the transmission was increased by an average of 10% over the visible range of 400-700 nm. This is shown in FIG. 2, which presents the relationship between transmission and wavelength of a polystyrene petri dish given an antireflective treatment. The reduced reflection is evident in the contrast between the treated and untreated halves of the petri dish. The petri dish was placed against a black background with white text. The coating was conformally and readily applied to the surfaces and notably the edges.

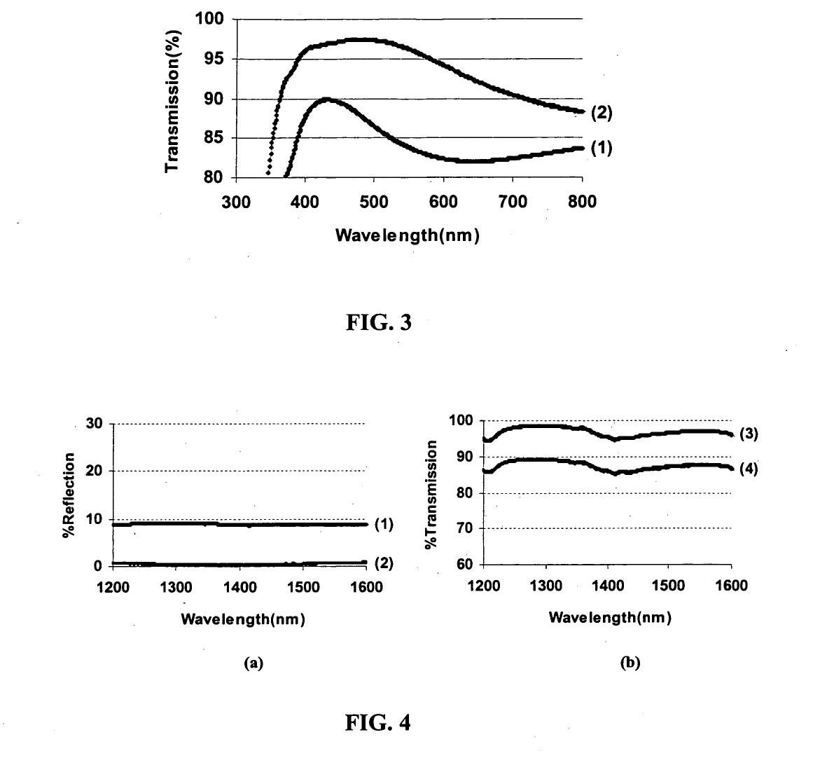

These coatings have been also applied to conducting surfaces such as indium-tin-oxide (ITO) coated-glass, which have refractive indices of around 1.7 and have high reflection losses. FIG. 3 shows an example of an antireflective coating applied to an ITO surface and the resultant improvement of transmission. These coatings can be useful in reducing losses of light in optical systems such as light-emitting devices that use ITO as an electrode. This process is not limited by size of the coated object, which allows coating of complex, large areas as well as contoured shapes such as lenses to be accomplished.

Additionally, the antireflective coatings can be precisely tailored to exhibit low reflection for various bandwidths in the visible and near-IR spectrum. This is illustrated in FIG. 4 for an antireflective film including a 21-layer PAH/PAA coating given the low-pH porosity treatment mentioned above on a polystyrene substrate. The reflection from both polystyrene surfaces was reduced from an average of 8.9% to 0.35% in the range of 1200-1600 nm. Although transmission is limited by inherent materials absorption losses, it was increased by greater than 10% in this range. The reduced reflection can be attributed to a graded porosity, which is suggested by atomic force microscopy (AFM) imaging of the porous structures. AFM images show that nanoporous structures can be systematically created using this process. Depth profiling of the surface indicates a progressively narrowing pore diameter, which can result in an effective grading of the index of refraction. Modeling of the system suggests that some level of gradation in index of refraction exists in these materials, and details of the profile relates to the treatment conditions. Other pH conditions at which the PAH/PAA films can be made nanoporous can be used to produce broadband antireflective coatings.

The process can conformally coat any object or substrate of virtually any size, shape, or material, with precisely tuned coating parameters, such as: thickness, composition, roughness, and wettability. Optical properties such as the index of refraction can be controlled to create a bandwidth of high optical transparency and low reflection. Antireflective coatings can be made on a variety of sizes of glass and plastics and foresee no limitation in terms of substrate, size, shape, or quantity. The optical transparency can be advantageously controlled for any polymer substrate, independent of shape or size while drastically reducing surface reflection. The resultant polymeric surfaces are rendered suitable for optical applications that require high transparency, reduced glare and reflections, as well as high contrast, with improved visibility and legibility of text. A remarkable quality of this process is that it is completely aqueous-based and hence very environmentally benign.

The process can be used to form antireflective and antiglare coatings on polymeric substrates. The simple and highly versatile process can create molecular-level engineered conformal thin films that function as low-cost, high-performance antireflection and antiglare coatings. The method can uniformly coat both sides of a substrate at once to produce defect and pinhole-free transparent coatings. The process can be used to produce high-performance polymeric optical components, including flat panel displays and solar cells.

Polyelectrolyte multilayers can be patterned with regions of selective nanoporosity. Patterning can be achieved, for example, by inexpensive, conventional ink-jet printing the porosity-inducing medium onto the non-porous film surface followed by a rinsing step in aqueous solution. The patterned coating is a selectively porous film in the regions that were printed by the porosity-inducing medium with the feature sizes able to have a resolution of <100 μm. Alternately, the non-porous polymer film can be removed/dissolved by ink-jet printing a film-removing medium, for example, a pH 1.5 or lower aqueous solution, onto the film. The film that remains, for example, in the specified pattern, can then be made nanoporous by the described methods. Besides inkjet printing, other common patterning methods can be used to achieve patterned nanoporous materials.

The generation of nanoporosity is reversible. The film can be cycled between a nanoporous and non-porous state by, for example, rinsing the film with a nanopore-removing medium, such as a higher pH medium after generating the nanopores or not rinsing the film, respectively. A nanopore-altering medium can add or remove nanopores. For example, an acidic aqueous solution could add nanopores; or a neutral aqueous solution could remove nanopores. A nanopore-altering medium can change the size of existing nanopores. Cycling of films can be used in membrane technologies, biomaterials, and stimulus-responsive applications in which transient nanoporous coatings modify surface properties of a substrate. More specifically, the rate of drug delivery can be controlled by altering the nanoporosity of a film in a delivery device. Nanoporosity is increased to speed the rate of delivery or nanoporosity is decreased to slow the rate of delivery. The nanoporosity of a film can be cycled multiple times. Pores can be filled with a material with a desired property. For exmaple, nanopores can be filled with a liquid crystal.

Other embodiments are within the scope of the following claims.

1-64. (canceled)

65. A device for delivering a compound, comprising:
a nanoporous polymeric material; and
a compound in contact with the polymeric material.

66. The device of claim 65, wherein the compound is located in an aqueous medium.

67. The device of claim 66, wherein the aqueous medium has a pH of less than 7.

68. The device of claim 66, wherein the aqueous medium has a pH of less than 3.

69. The device of claim 66, wherein the aqueous medium has a salt concentration of less than 1 molar.

70. The device of claim 65, wherein the polymeric material includes a polyelectrolyte.

71. The device of claim 65, wherein the compound is enclosed by the polymeric material.

72. The device of claim 65, wherein the compound is embedded in the polymeric material.

73. The device of claim 65, wherein the compound is a drug.
